(19) United States
(12) Patent Application Publication
(10) Pub. No.: US 2020/0161723 A1
(43) Pub. Date: May 21, 2020

(54) COOLING DEVICE AND BATTERY APPARATUS INCLUDING THE SAME

(71) Applicant: SAMSUNG ELECTRONICS CO., LTD., Suwon-si (KR)

(72) Inventors: Ji-Young JEONG, Hwaseong-si (KR); Jeongsik KO, Hanam-si (KR); Daebong JUNG, Seongnam-si (KR)

(73) Assignee: SAMSUNG ELECTRONICS CO., LTD., Suwon-si (KR)

(21) Appl. No.: 16/374,946

(22) Filed: Apr. 4, 2019

(30) Foreign Application Priority Data
Nov. 19, 2018 (KR) 10-2018-0142969

(51) Int. Cl. H01M 10/613; H01M 10/6556; H01M 10/6552; H01M 10/625

(52) U.S. Cl. CPC H01M 10/613; H01M 10/6556; H01M 2220/20; H01M 10/625; H01M 10/6552

(57) ABSTRACT

A cooling device and a battery apparatus including the cooling device is provided. The cooling device includes a heat transfer body configured to be in contact with at least a portion of the battery pack to absorb heat from the portion of the battery pack through a first coolant included in the heat transfer body and a cooling flow path disposed relative to the heat transfer body, and configured to cool the heat absorbed from the heat transfer body through a second coolant included in the cooling flow path.

### CROSS-REFERENCE TO RELATED APPLICATION

This application claims the benefit under 35 USC § 119(a) of Korean Patent Application No. 10-2018-0142969 filed on Nov. 19, 2018 in the Korean Intellectual Property Office, the entire disclosure of which is incorporated herein by reference for all purposes.

### BACKGROUND

### 1. Field

The following description relates to a cooling device and a battery apparatus including the cooling device.

### 2. Description of Related Art

A battery may include a high-voltage battery pack including a plurality of battery modules. The battery pack may generate heat during a charging and discharging process. In response to heat being generated in the battery pack, a performance of the battery may be degraded, or a life span of the battery may be reduced. Therefore, there is a desire for a cooling device for transferring the generated heat out of the battery to maintain the battery at a predetermined temperature to extend the life span of the battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a cooling device includes a heat transfer body, disposed to be in contact with at least a portion of a battery pack, and configured to absorb heat from the portion of the battery pack through a first coolant in the heat transfer body, and a cooling flow path disposed relative to the heat transfer body, and configured to cool the heat absorbed from the heat transfer body through a second coolant included in the cooling flow path.

The portion of the battery pack may be a portion in which electric elements are most densely located in the battery pack.

The portion of the battery pack may include one of a tap of a battery module of a plurality of battery modules included in the battery pack, and a busbar configured to electrically connect the plurality of battery modules.

The first coolant may absorb or emit heat through a phase change in a closed space.

The heat transfer body may be a heat pipe.

The first coolant may transfer the heat based on one or more of a capillary process in a closed space of the heat transfer body, or a convection process in the closed space.

The second coolant may be a liquid coolant.

The heat transfer body may be configured to be in contact with a busbar which connects battery modules included in the battery pack, and absorb heat emitted from the busbar through the first coolant.

The heat transfer body may be configured to be in contact with a busbar and a battery module included in the battery pack, and absorb heat emitted from the busbar and the battery module through the first coolant.

The heat transfer body may be configured to electrically connect taps of battery modules included in the battery pack, and absorb heat from the taps through the first coolant.

The heat transfer body may be configured to be in contact with busbars included in the battery pack, and absorb heat from the busbars through the first coolant.

The heat transfer body may be configured to be in contact with battery modules included in the battery pack such that a flatness of the battery pack is greater than or equal to a predetermined reference value.

The heat transfer body may be configured to be in contact with battery modules and busbars included in the battery pack, and absorb heat from the busbars and the battery modules through the first coolant.

The cooling flow path may be further configured to be in contact with a battery module included in the battery pack and absorb heat from the battery module through the second coolant.

In another general aspect, a battery apparatus includes a battery pack, a heat transfer body, disposed to be in contact with at least a portion of the battery pack, and configured to absorb heat from the portion of the battery pack through a first coolant included in the heat transfer body, and a cooling flow path disposed relative to the heat transfer body, and configured to cool the heat absorbed from the heat transfer body through a second coolant included in the cooling flow path.

The portion of the battery pack may be a portion in which electric elements are most densely located in the battery pack.

The portion of the battery pack may include one of a tap of a battery module of a plurality of battery modules included in the battery pack, and a busbar configured to electrically connect the plurality of battery modules.

The first coolant may absorb or emit heat through a phase change in a closed space.

The heat transfer body may be a heat pipe.

The second coolant may be a liquid coolant.

In another general aspect, a battery system includes a battery pack, a first cooling structure, configured to be disposed in contact with at least one busbar of the battery pack, and comprising a first coolant that absorbs heat from the battery pack, a second cooling structure, configured to be disposed in contact with the first cooling structure, and comprising a second coolant that cools the heat absorbed by the first cooling structure, and a heat exchanger, configured to cool the second coolant, and recycle the cooled second coolant to the second cooling structure.

Other features and aspects will be apparent from the following detailed description, the drawings, and the claims.

### BRIEF DESCRIPTION OF THE DRAWINGS

FIG. 1 illustrates an example of a battery apparatus, in accordance with one or more embodiments;

FIGS. 2 through 4 illustrate examples of a cooling device, in accordance with one or more embodiments;

FIG. 5 illustrates an example of a heat transfer body included in a cooling device, in accordance with one or more embodiments;

FIGS. 6 and 7 illustrate examples of a heat transfer body included in a cooling device, in accordance with one or more embodiments;

FIGS. 8 through 12 illustrate examples of a heat transfer body included in a cooling device, in accordance with one or more embodiments; and

FIG. 13 illustrates an example of a cooling flow path included in a cooling device, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

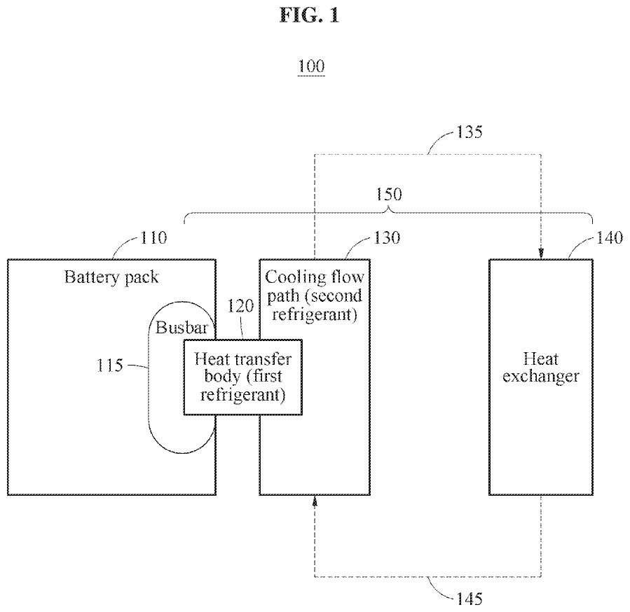

FIG. 1 is a diagram illustrating an example of a battery apparatus in accordance with one or more embodiments.

Referring to FIG. 1, a battery apparatus 100 includes a battery pack 110 and a cooling device 150.

The battery pack 110 supplies a power to an apparatus, for example, an electric vehicle and a hybrid vehicle in which the battery apparatus 100 is located. The battery pack 110 includes a plurality of battery modules. Each of the battery modules includes a plurality of battery cells.

Each of the battery modules includes a tap. The tap is a positive (+) terminal or a negative (−) terminal of the battery module. The tap is used to output a power stored in the battery module, or input a current to be stored in the battery module. The tap is a portion of the battery pack 110 in which electric elements are most densely located in the battery pack 110. For example, in the tap, electric elements such as wires connected to a sensor and a battery management system (BMS) may be densely located. As such, since the electric elements are most densely located in the tap of the battery pack 110, the tap may generate a large amount of heat.

A busbar 115 connects taps of adjacent battery modules of the battery pack 110, thereby electrically connecting the battery modules. Since the busbar 115 may be in direct contact with the tap of each of the battery modules, the busbar 115 is also a portion of the battery pack 110 that corresponds to the portion in which the electric elements are most densely located in the battery pack 110. Also, since the heat generated in the tap may be easily transferred to the busbar 115, the busbar 115 also corresponds to a portion of the battery module 110 in which a large amount of heat is generated in the battery pack 110.

The cooling device 150 may include a heat transfer body 120, a cooling flow path 130, and a heat exchanger 140.

The heat transfer body 120 may be in contact with at least a portion of the battery pack 110 to absorb heat from the at least a portion of the battery pack 110 through a first refrigerant in the heat transfer body 120. Here, the at least a portion of the battery pack 110 may be a portion of the battery pack 110 in which electric elements are most densely located and a largest amount of heat is generated in the battery pack 110. The at least a portion of the battery pack 110 may include, for example, any one of the busbar 115 and a tap of a battery module of the battery pack 110.

The heat transfer body 120 may include the first refrigerant or coolant that absorbs or emits heat through a phase change in a closed space. The first refrigerant may be a working fluid that transfers the heat based on a capillary phenomenon or process in a closed space of the heat transfer body 120. Also, the first refrigerant transfers the heat based on a convection phenomenon in the closed space of the heat transfer body 120. The heat transfer body 120 absorbs the heat from the busbar 115 of the battery pack 110 and transfers the heat to the cooling flow path 130. The heat transfer body 120 may be, for example, a heat pipe. Herein, it is noted that use of the term “may” with respect to an example or embodiment, e.g., as to what an example or embodiment may include or implement, means that at least one example or embodiment exists where such a feature is included or implemented while all examples and embodiments are not limited thereto.

The cooling flow path 130 may be in contact with the heat transfer body 120 to cool the heat absorbed from the heat transfer body 120 through a second refrigerant or coolant included in the cooling flow path 130. The second refrigerant which has absorbed the heat from the heat transfer body 120, transfers the heat to the heat exchanger 140 through a path 135, and dissipates the heat in the heat exchanger 140, thereby cooling the heat absorbed from the heat transfer body 120. The cooled second refrigerant is recycled, via path 145, to the cooling flow path 130 which is in contact with the heat transfer body 120 to absorb the heat from the heat transfer body 120. The second refrigerant may be, for example, a liquid refrigerant, but this is only an example. When compared to a gas refrigerant, the liquid refrigerant may store a larger amount of heat per volume with a large specific heat and perform a heat exchange with a large thermal conductivity. Thus, an effective cooling may be expected. Depending on an example, a gas refrigerant may be used as the second refrigerant.

The heat exchanger 140 cools the second refrigerant which has absorbed the heat from the heat transfer body 120 such that the cooled second refrigerant absorbs heat from the heat transfer body 120 again.

In an example, the battery pack 110 may be effectively cooled by transferring heat generated in the busbar 115, or the tap of the battery module to the cooling flow path 130 through the heat transfer body 120 so as to be cooled. Also, the heat transfer body 120 and the cooling flow path 130, which, in an example, may implement a liquid refrigerant, may be used to effectively cool the busbar 115, in which electric elements are densely located, or the tap of the battery module without risk of leakage.

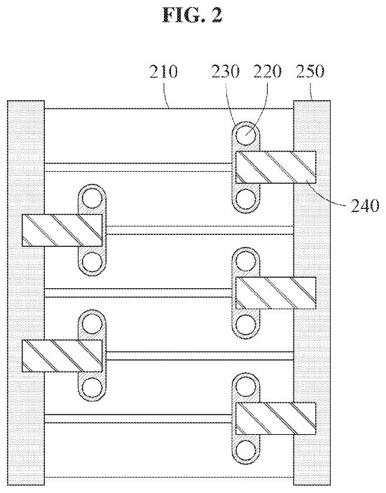

FIGS. 2 through 4 are diagrams illustrating examples of a cooling device in accordance with one or more embodiments.

FIG. 2 is a top view illustrating an example of a cooling device.

As illustrated in FIG. 2, a battery module 210 in a battery pack includes a tap 220. The tap 220 is electrically connected to a tap of an adjacent battery module through a busbar 230.

A heat transfer body 240 may be in contact with the busbar 230 to absorb heat from the busbar 230 using a first refrigerant, and may emit the absorbed heat to a cooling flow path 250. The cooling flow path 250 is in contact with the heat transfer body 240 to absorb heat from the heat transfer body 240 through a second refrigerant and cool the absorbed heat.

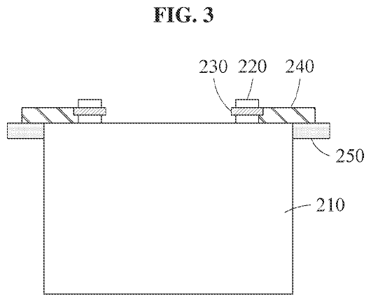

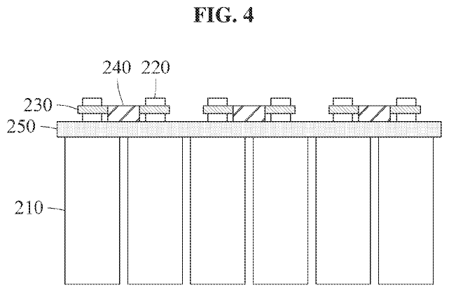

FIG. 3 is a front view illustrating an example of a cooling device, and FIG. 4 is a side view illustrating an example of a cooling device.

Referring to FIGS. 3 and 4, the tap 220, located in an upper portion of the battery module 210, may be electrically connected to a tap of an adjacent battery module through the busbar 230. The heat transfer body 240 may be in contact with the busbar 230 to absorb heat from the busbar 230. The cooling flow path 250 may be in contact with the heat transfer body 240 to cool the heat absorbed from the heat transfer body 240.

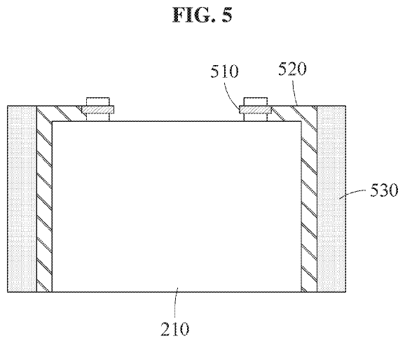

FIG. 5 is a diagram illustrating an example of a heat transfer body included in a cooling device in accordance with one or more embodiments.

FIG. 5 is a front view illustrating an example of a heat transfer body 520. The heat transfer body 520 may be in contact with the battery module 210 as well as a busbar 510. Through this, the heat transfer body 520 may absorb heat from the busbar 510 and the battery module 210. A cooling flow path 530 may be in contact with a large area (e.g., a large surface), of the heat transfer body 520 so as to more effectively absorb the heat from the heat transfer body 520, and cool the absorbed heat. Since the heat is also generated in the battery module 210, the heat transfer body 520, which is in contact with side surfaces of the busbar 510 and the battery module 210, may efficiently cool the heat generated in the battery pack.

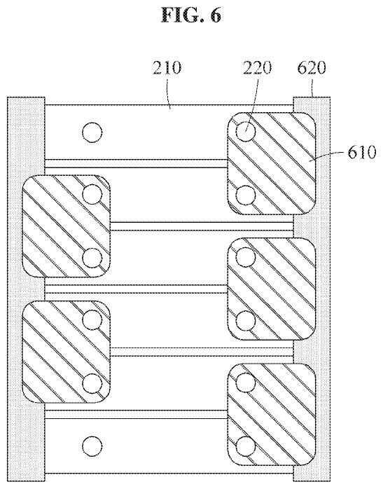

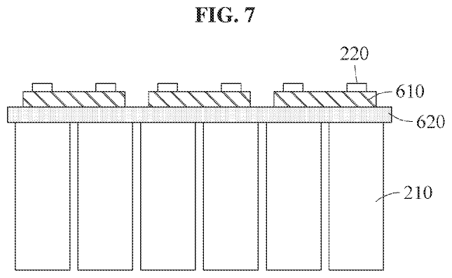

FIGS. 6 and 7 are diagrams illustrating examples of a heat transfer body included in a cooling device in accordance with one or more embodiments. FIG. 6 is a top view illustrating an example of a heat transfer body 610 and FIG. 7 is a side view illustrating an example of the heat transfer body 610.

Referring to FIGS. 6 and 7, the heat transfer body 610 electrically connects taps 220 of battery modules 210. The heat transfer body 610 is in contact with the taps 220 of the adjacent battery modules 210 so as to absorb heat from the taps 220 through a first refrigerant in the heat transfer body 610. The heat transfer body 610 not only absorbs the heat from the taps 220, but may also perform a function of a busbar as described above, thereby replacing the busbar in FIGS. 1-5. A cooling flow path 620 absorbs heat from the heat transfer body 610 and cools the absorbed heat.

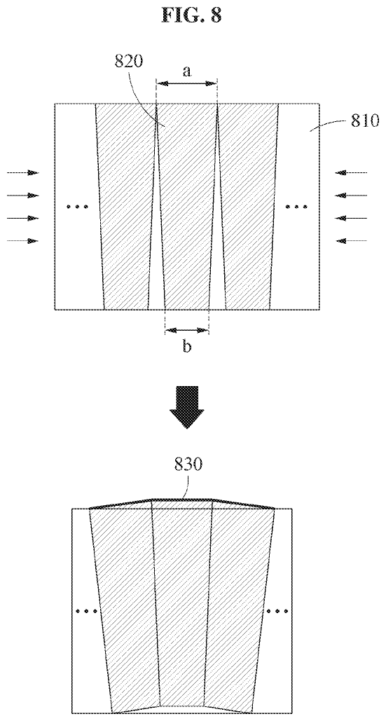

FIGS. 8 through 12 are diagrams illustrating examples of a heat transfer body included in a cooling device in accordance with one or more embodiments.

FIG. 8 illustrates an example for explaining a flatness of a battery pack 810. The battery pack 810 includes a plurality of battery modules 820. A lower width “b” of a battery module 820 may be less than an upper width “a” of the battery module 820, such that the battery module 820 may be easily inserted into, or removed from, the battery pack 810.

When a pressure is applied from both sides of the battery pack 810 for packaging of the battery pack 810, an upper portion 830 of the battery pack 810 may protrude due to the shape of the battery module 820, and a lower portion of the battery pack 810 may be empty. In other words, a flatness of the battery pack 810 may be reduced. Also, a cooling flow path located in the lower portion of the battery pack 810 may not be in close contact with the battery module 820 due to the empty space, which may reduce a cooling effect. Thus, the flatness of the battery pack 810 may be maintained to be greater than or equal to a predetermined reference value.

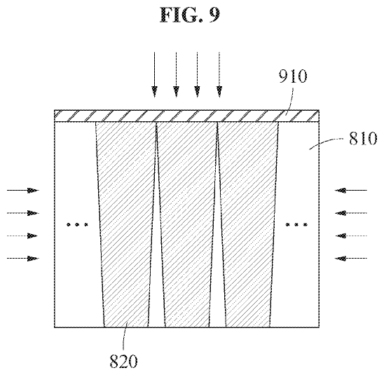

FIG. 9 illustrates a heat transfer body 910 that is in close contact with battery modules 820 such that a flatness of the battery pack 810 is greater than or equal to a predetermined reference value. The heat transfer body 910 may be in close contact with a plurality of battery modules 820 included in the battery pack 810 so as to maintain the flatness of the battery pack 810 to be greater than or equal to the predetermined reference value, when packaging the battery pack 810.

Accordingly, a cooling flow path located in a lower portion of the battery pack 810 may be in close contact with the battery module 820 to effectively cool the battery module 820, so that a difference in temperature between battery cells included in the battery module may be reduced.

Additionally, by implementing the heat transfer body 910 in a single long form, manufacturing costs may be reduced, and fabrication and installation may be achieved in an easier manner when compared to a structure in which one heat transfer body is provided for each busbar.

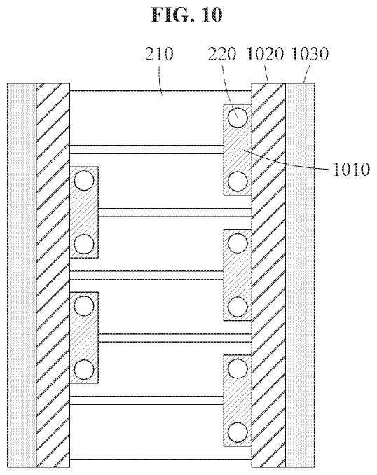

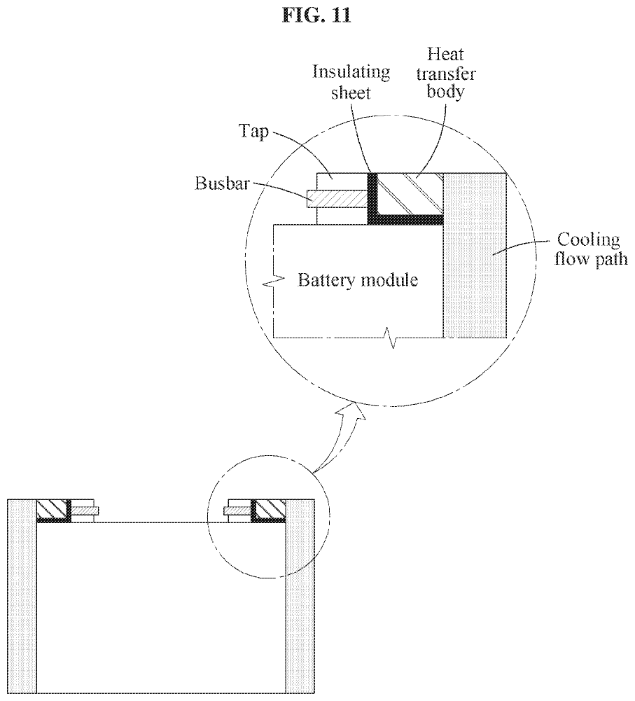

FIG. 10 is a top view illustrating an example of a heat transfer body 1020 and FIG. 11 is a front view illustrating an example of the heat transfer body 1020.

Referring to FIGS. 10 and 11, in an example, the heat transfer body 1020 may be in a form of a long bar. The heat transfer body 1020 may be in contact with busbars 1010 included in a battery pack, and may absorb heat from the busbars 1010 through a first refrigerant. Additionally, the heat transfer body 1020 may be in close contact with the battery modules 210 included in the battery pack, such that a flatness of the battery pack is greater than or equal to a predetermined reference value. A cooling flow path 1030 may be in contact with the heat transfer body 1020, and may cool the heat absorbed from the heat transfer body 1020.

To prevent the busbars 1010 from being electrically connected to each other in response to the heat transfer body 1020 contacting the busbars 1010, insulating sheets may be arranged between the heat transfer body 1020 and the busbars 1010. In addition, the insulating sheets may be arranged in various ways to prevent the battery modules from being electrically connected to each other in an unintended direction due to at least one of the heat transfer body 1020 and the cooling flow path 1030

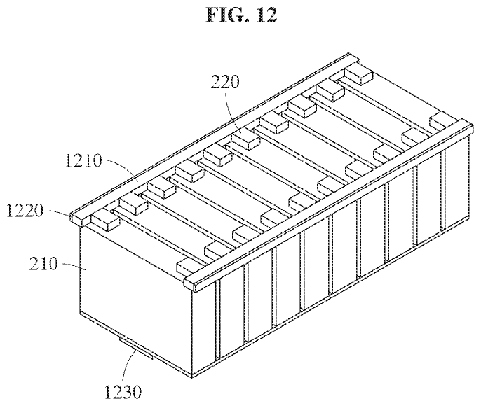

FIG. 12 is a perspective view illustrating an example of a heat transfer body in accordance with one or more embodiments.

Referring to FIG. 12, the taps 220 of the adjacent battery modules 210 may be electrically connected through a busbar (not shown), so that a heat transfer body 1210 in contact with the busbar absorbs heat from the busbar. A first cooling flow path 1220 in contact with the heat transfer body 1210 cools the heat absorbed from the heat transfer body 1210.

Additionally, the cooling process may be additionally performed through a second cooling flow path 1230 located in a lower portion of a battery pack. When the heat transfer body 1210 is in close contact with the battery modules 210, a flatness of the battery pack is maintained to be greater than or equal to a predetermined reference value. Through this, battery cooling through the second cooling flow path 1230 may be effectively performed without a temperature deviation.

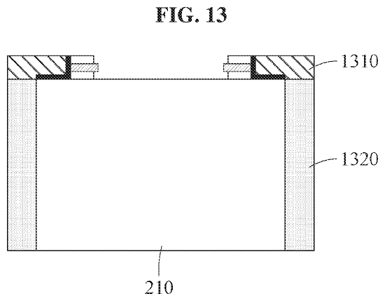

FIG. 13 is a diagram illustrating an example of a cooling flow path included in a cooling device in accordance with one or more embodiments.

FIG. 13 is a front view illustrating an example of a cooling flow path 1320. In the example of FIG. 13, the cooling flow path 1320 may be in contact with a heat transfer body 1310 to absorb heat from the heat transfer body 1310. In the example of FIG. 13, the cooling flow path 1320 may be in contact with a large area of the battery module 210 in addition to the heat transfer body 1310, so that the cooling flow path 1320 may absorb the heat from the battery module 210 and the heat transfer body 1310, and perform a cooling process. Accordingly, battery pack cooling may be more efficiently performed.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A cooling device comprising:
a heat transfer body disposed to be in contact with at least a portion of a battery pack, and configured to absorb heat from the portion of the battery pack through a first coolant in the heat transfer body; and
a cooling flow path disposed relative to the heat transfer body, and configured to cool the heat absorbed from the heat transfer body through a second coolant included in the cooling flow path.

2. The cooling device of claim 1, wherein the portion of the battery pack is a portion in which electric elements are most densely located in the battery pack.

3. The cooling device of claim 1, wherein the portion of the battery pack comprises one of a tap of a battery module of a plurality of battery modules included in the battery pack, and a busbar configured to electrically connect the plurality of battery modules.

4. The cooling device of claim 1, wherein the first coolant absorbs or emits heat through a phase change in a closed space.

5. The cooling device of claim 1, wherein the heat transfer body is a heat pipe.

6. The cooling device of claim 1, wherein the first coolant transfers the heat based on either one or both of a capillary process in a closed space of the heat transfer body, and a convection process in the closed space.

7. The cooling device of claim 1, wherein the second coolant is a liquid coolant.

8. The cooling device of claim 1, wherein the heat transfer body is configured to be in contact with a busbar which connects battery modules included in the battery pack, and absorb heat emitted from the busbar through the first coolant.

9. The cooling device of claim 1, wherein the heat transfer body is configured to be in contact with a busbar and a battery module included in the battery pack, and absorb heat emitted from the busbar and the battery module through the first coolant.

10. The cooling device of claim 1, wherein the heat transfer body is configured to electrically connect taps of battery modules included in the battery pack, and absorb heat from the taps through the first coolant.

11. The cooling device of claim 1, wherein the heat transfer body is configured to be in contact with busbars included in the battery pack, and absorb heat from the busbars through the first coolant.

12. The cooling device of claim 11, wherein the heat transfer body is configured to be in contact with battery modules included in the battery pack such that a flatness of the battery pack is greater than or equal to a predetermined reference value.

13. The cooling device of claim 1, wherein the heat transfer body is configured to be in contact with battery modules and busbars included in the battery pack, and absorb heat from the busbars and the battery modules through the first coolant.

14. The cooling device of claim 1, wherein the cooling flow path is further configured to be in contact with a battery module included in the battery pack and absorb heat from the battery module through the second coolant.

15. A battery apparatus comprising:
a battery pack;
a heat transfer body disposed to be in contact with at least a portion of the battery pack, and configured to absorb heat from the portion of the battery pack through a first coolant included in the heat transfer body; and
a cooling flow path disposed relative to the heat transfer body, and configured to cool the heat absorbed from the heat transfer body through a second coolant included in the cooling flow path.

16. The battery apparatus of claim 15, wherein the portion of the battery pack is a portion in which electric elements are most densely located in the battery pack.

17. The battery apparatus of claim 15, wherein the portion of the battery pack comprises one of a tap of a battery module of a plurality of battery modules included in the battery pack, and a busbar configured to electrically connect the plurality of battery modules.

18. The battery apparatus of claim 15, wherein the first coolant absorbs or emits heat through a phase change in a closed space.

19. The battery apparatus of claim 15, wherein the heat transfer body is a heat pipe.

20. The battery apparatus of claim 15, wherein the second coolant is a liquid coolant.

21. A battery system comprising:
a battery pack;
a first cooling structure, configured to be disposed in contact with at least one busbar of the battery pack, and comprising a first coolant that absorbs heat from the battery pack;
a second cooling structure, configured to be disposed in contact with the first cooling structure, and comprising a second coolant that cools the heat absorbed by the first cooling structure; and
a heat exchanger configured to cool the second coolant and recycle the cooled second coolant to the second cooling structure.
